(19) United States
(12) Patent Application Publication
(10) Pub. No.: US 2026/0242706 A1
(43) Pub. Date: Aug. 20, 2026

(54) SYSTEMS AND METHODS FOR MATURATION OF DISTILLED SPIRITS

(71) Applicant: Citadel Structures, LLC, Lebanon, KY (US)

(72) Inventor: Mark Boone, Lebanon, KY (US)

(73) Assignee: Citadel Structures, LLC, Lebanon, KY (US)

(21) Appl. No.: 19/545,940

(22) Filed: Feb. 20, 2026

Related U.S. Application Data
(60) Provisional application No. 63/760,758, filed on Feb. 20, 2025.

(51) Int. Cl. C12H 1/22; B65D 88/74

(52) U.S. Cl. CPC C12H 1/22; B65D 88/744; B65D 2588/746

(57) ABSTRACT

The present disclosure relates to systems for the maturation of distilled spirits. In particular, disclosed herein is an apparatus for maturing distilled spirits comprising a shipping container within which two rail systems are positioned on either side of a central aisle. Each rail system runs the length of the shipping container and comprises three rows of opposing rails, with such rails spaced horizontally and vertical apart such that each set of opposing rails is configured to support at least one barrel. Below the three rows of opposing rails is at least one runner on the floor of the rail system configured to prevent barrels from touching the bottom surface of the shipping container. The tapered rails and runner are configured to allow the storage of barrels in each of the four vertical rows of each rail system with two rail systems per shipping container. The presence of a central aisle enables a user access to each barrel during storage. The apparatus can be further configured to include one or more thermostats, fans, and louvers to modulate the climate within the shipping container to adjust the rate of maturation of distilled spirits within the barrels.

### CROSS-REFERENCE TO RELATED APPLICATION

This application claims priority to U.S. Provisional Application No. 63/760,758, entitled “Systems and Methods for Maturation of Distilled Spirits” and filed on Feb. 20, 2025, the entire contents of which is incorporated herein by reference.

### BACKGROUND OF THE INVENTION

Maturation of distilled spirits, such as whiskey, requires long-term storage in wooden barrels. The interaction between the distillate and wooden barrels is essential for developing both flavor and color; for example, both the color and flavor of whiskey is derived from barrel interaction. To appropriately mature distilled spirits, barrels should be stored in a facility that can experience fluctuations in temperature and humidity. The storage of such barrels, however, is typically done in warehouse facilities that are cost prohibitive to smaller distillers. Similarly, even for large distilleries, the cost of building a new warehouse to increase storage capacity can be a significant financial burden.

One alternative to conventional warehouse facilities is to store barrels in shipping containers. Conventional use of such shipping containers is problematic, however, due to limited storage capacity using existing designs, limited access to the barrels-for example to rotate such barrels-while in storage, and limited control over the environmental conditions within the containers that affects the muration of distilled spirits within the barrels.

As a result, there remains an unmet need for lower cost, modular solutions for the maturation of distilled spirits. Further, there remains an unmet need for controlling the maturation process for such distilled spirits, which under conventional conditions can take many years to complete.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts an end view of a shipping container within which is located a central passageway and opposing rail systems on either side of the central passageway, wherein each rail system comprises three rows of opposing rails and a row of two flat-topped runners along the bottom interior surface of the shipping container, wherein the rails and runners are configured to support barrels. The figure is not shown to scale.

FIG. 2 depicts an end view of a shipping container within which is located a central passageway and opposing rail systems on either side of the central passageway, wherein each rail system comprises three rows of opposing rails and a row of two tapered top runners along the bottom interior surface of the shipping container, wherein the rails and runners are configured to support barrels. The figure is not shown to scale.

### DETAILED DESCRIPTION

The present disclosure relates to systems for the maturation of distilled spirits. In particular, disclosed herein is an apparatus for maturing distilled spirits comprising a shipping container within which two rail systems are positioned on either side of a central aisle. Each rail system runs the length of the shipping container and comprises three rows of opposing rails, with such rails spaced horizontally and vertical apart such that each set of opposing rails is configured to support at least one barrel. Below the three rows of opposing rails is at least one runner on the floor of the rail system configured to prevent barrels from touching the bottom surface of the shipping container. The tapered rails and runner are configured to allow the storage of barrels in each of the four vertical rows of each rail system with two rail systems in a single shipping container. The presence of a central aisle enables a user access to each barrel during storage. The apparatus can be further configured to include one or more thermostats, fans, and louvers to modulate the climate within the shipping container to adjust the rate of maturation of distilled spirits within the barrels. The number of barrels that the apparatus can store is dependent on the length of the shipping container.

The examples, applications, descriptions and content disclosed herein are exemplary and explanatory, and are non-limiting and non-restrictive in any way.

All scientific terms used herein have the same meaning as commonly used and understood by one of ordinary skill in the art. Examples, materials, methods, figures and tables are illustrative only and not intended to be limiting.

As used herein, “barrel” means a wooden barrel. Barrel can include a 53 gallon whiskey barrel or other barrels known in the art.

As used herein, “rail” means a support positioned horizontal along the length of a shipping container. A rail may either be a single continguous piece or a plurality of individual pieces. A rail may be comprised of wood, metal, plastic, rubber, or other material capable of supporting the weight of one or more barrels.

As used herein, “runner” means a support positioned along the length of a shipping container at the bottom of a rail system. A runner may either be a single continguous piece or a plurality of individual pieces. A runner may be comprised of wood, metal, plastic, rubber, or other material capable of supporting the weight of one or more barrels.

As used herein, “shipping container” means a commercial shipping container approximately 8 feet wide and 8 feet 6 inches in height. Various lengths are possible, with either 19 feet 10 inches or 40 feet in length being the most common.

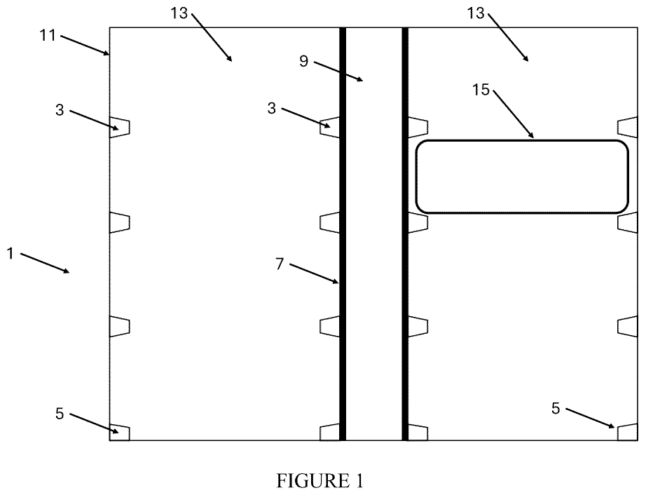

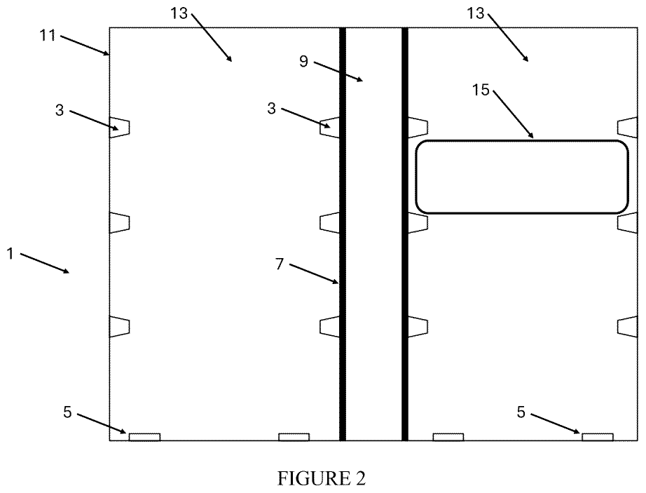

The apparatus 1 comprises two rail systems 13, each rail system 13 consisting of three rows of opposing rails 3 that span the length of the shipping container 11, with such rails 3 spaced horizontally and vertically apart such that each set of opposing rails 3 is configured to support at least one whiskey barrel. FIGS. 1 and 2 each depict an example whiskey barrel 15 resting on two opposing rails 3. Each rail 3 is tapered vertically such that the height of the rail decreases toward the respective opposing rail 3. In certain configurations, the rails 3 have a trapezoid shape (FIG. 1). The tapered design is configured to allow centering of barrels on the rails 3 and to enable the barrels to roll evenly along the rails 3. In one example, each rail 3 is approximately 4 inches wide, approximately 4 inches in height at the point that it attaches to a rail post 7 or interior surface of the shipping container 11 and approximately 2½ inches in height at the point distal from its point of attachment (FIGS. 1 and 2). Other dimensions are also possible. In addition to tapered rails 3, curved rails may also be used, for example such that the surface of the rail 3 in contact with the barrel is either concave or convex.

Below the lower set of opposing rails 3 is at least one runner 5 positioned along the bottom of each rail system on the bottom interior surface of the shipping container 11 such that each runner 5 is configured to prevent a barrel from touching the bottom interior surface of the shipping container 11. In certain embodiments, each runner 5 is configured to have a flat surface facing toward the top of the shipping container such that the top surface of the runner 5 is parallel to the floor of the shipping container 11. An example of flat-topped runners 5 is shown in FIG. 1. Alternatively, the top surface of each runner 5 is curved or tapered. An example of a tapered top runners 5 is shown in FIG. 2.

The rails 3 proximal to the center of the shipping container 11 are attached to one or more rail posts 7. In certain configurations, the rail posts 7 for the two opposing rail systems 13 are spaced 18 inches apart (i.e., the width of the central aisle is 18 inches) forming a passageway 9. Other configurations are possible, such that the rail posts 7 for the opposing rail systems 13 are 16-20 inches apart (i.e., the width of the central aisle is 16-20 inches wide). The rails 3 proximal to the exterior of the shipping container 11 may be attached either to rail posts 7 or to the interior surface of the shipping container 11. In one example, each rail post 7 is 1½ inches by 7 inches and extends from the floor to the ceiling of the shipping container 11. Other dimensions for the rail post 7 are possible.

The apparatus 1 can further include at least one thermostat to monitor the temperature within the shipping container 11. At least one thermostat may also be configured to monitor the temperature outside of the shipping container 11. The apparatus 1 can further include at least one humidostat to monitor the humidity within the shipping container 11. At least one humidostat may also be configured to monitor the humidity outside of the shipping container 11. Each thermostat and humidostat may be attached within or without the shipping 11 container as known to those of skill in the art.

The apparatus 1 can include at least one louver vent on or proximal to a door of the shipping container 11 and at least one fan on or proximal to the wall of the shipping container 11 opposite to a door of the shipping container. Other configurations of the at least one louver and at least one fan are contemplated, as known to those of ordinary skill in the art. In some embodiments, the apparatus 1 includes at least one louver at least 16 inches in diameter and at least one fan at least 16 inches in diameter. Each louver can be configured to open or close depending on the temperature or humidity within or outside of the shipping container 11 measured by the least one thermostat or humidostat, respectively. Similarly, each fan can be configured to activate depending on the temperature or humidity within or outside of the shipping container 11 measured by the least one thermostat or humidostat, respectively.

The apparatus 1 can further include at least one heater configured to increase temperature within the shipping container 11 upon command, which may be preprogrammed, by a user. The apparatus 1 can further include at least one humidifier to increase the humidity within the shipping container 11 upon a command, which may be preprogrammed, by a user. In certain embodiments, the apparatus 1 is powered by solar power.

As an example, a humidistat and thermostat measuring conditions on the exterior of the shipping container 11 can be configured to trigger at least one louver to open and at least one fan to activate for a 24-hour period when the ambient conditions outside of the shipping container deviate by 40° F. or 40% moisture from the conditions within the shipping container. Once equilibrium with the exterior temperature or humidity is achieved, the at least one louver and at least one fan can be programmed to deactivate for a predetermined period of time, for example for a period of 60 days.

As another example, the apparatus 1 can include at least one humidifier and at least one heater to increase the humidity and temperature, respectively, within the shipping container 11 relative to the humidity and temperature outside of the shipping container 11.

The apparatus 1 disclosed herein comprises sustainable energy and safety features. It includes solar power integration in that it: is equipped with solar panels to power all electrical components; reduces operational costs through renewable energy; minimizes environmental impact; provides energy independence; and offers potential tax incentives for green energy adoption. In terms of safety and lighting, it includes: explosion-proof interior lighting systems; meets or exceeds hazardous location safety requirements; offers enhanced visibility for barrel inspection and maintenance; offers reduced risk during operations; and comprises energy-efficient LED technology.

The external surface of at least one side wall of the shipping container 11 has a light reflectivity of at least 10 and/or the external surface of the roof has a light reflectivity of less than 75.

The disclosed systems and methods offers many advantages over conventional systems and methodologies including, but not limited to: lower cost storage facilities, modular storage options, increased storage capacity of approximately 25% compared to conventional storage solutions using shipping containers, improved access by a user by virtue of the central aisle, and more rapid maturation of distilled spirits by virtue of climate adjustment using thermostats, fans, and louvers. Regarding maturation, a single-layer barrel arrangement prevents the thermal isolation effects common in traditional barrel storage solutions, and reduced vertical stacking height compared to traditional storage solutions enables more uniform maturation. Regarding lower cost, the storage solutions disclosed herein are more affordable than building large warehouses (known as rickhouses), reducing initial investment and operational costs. The storage solutions disclosed herein also are a smaller size compared to conventional storage solutions and allows them to hold heat longer, accelerating the aging process while maintaining quality. Further, the storage solutions disclosed herein are equipped with thermostats and humidistats, allowing them to harness ambient temperatures and internal heat, creating a consistent maturation environment. Finally, the storage solutions disclosed herein comprise an exhaust fan system that ensures proper air circulation, mimicking the effects of a traditional rickhouse.

This method provides a practical solution for craft distillers, offering the potential for rapid maturation without sacrificing flavor complexity while maintaining high safety standards and environmental responsibility.

1. An apparatus comprising:
a shipping container;
two rail systems within the shipping container positioned on either side of a central aisle, wherein each rail system comprises: three rows of opposing rails; and at least one runner positioned below the bottom row of opposing rails, wherein three opposing rails are attached to at least one rail post proximal to the center of the shipping container and the other three opposing rails are attached to the interior wall of the shipping container.

2. The apparatus of claim 1, wherein the rails are tapered such that the height of the rail proximal to the center of the rail system is less than the height distal from the center of the rail system.

3. The apparatus of claim 1, wherein the central aisle is 18 inches wide.

4. The apparatus of claim 1, further comprising at least one thermostat.

5. The apparatus of claim 1, further comprising at least one humidostat.

6. The apparatus of claim 1, further comprising at least one heater.

7. The apparatus of claim 1, further comprising at least one humidifier.

8. The apparatus of claim 1, further comprising at least one louver and at last one fan.

9. The apparatus of claim 8, wherein the at least one louver is located on a door of the shipping container and the at least one fan is located on or proximal to the wall of the shipping container opposite to the door.

10. The apparatus of claim 1, wherein the external surface of the roof of the shipping container has a light reflectivity of less than 75.

11. The apparatus of claim 1, wherein the external surface of at least one side wall of the shipping container has a light reflectivity of at least 10.

12. An apparatus comprising:
a shipping container, wherein the external surface of at least one side wall of the shipping container has a light reflectivity of at least 10;
two rail systems within the shipping container positioned on either side of a central aisle, wherein each rail system comprises: three rows of opposing rails; and at least one runner positioned below the bottom row of opposing rails, wherein three opposing rails are attached to at least one rail post proximal to the center of the shipping container and the other three opposing rails are attached to the interior wall of the shipping container;
at least one thermostat;
at least one humidostat;
at least one fan;
at least one louver;
at least one heater; and
at least one humidifier.

13. An apparatus comprising:
a shipping container, wherein the external surface of the roof of the shipping container has a light reflectivity of less than 75;
two rail systems within the shipping container positioned on either side of a central aisle, wherein each rail system comprises: three rows of opposing rails; and at least one runner positioned below the bottom row of opposing rails, wherein three opposing rails are attached to at least one rail post proximal to the center of the shipping container and the other three opposing rails are attached to the interior wall of the shipping container;
at least one thermostat;
at least one humidostat;
at least one fan;
at least one louver;
at least one heater; and
at least one humidifier.
